(19) United States
(12) Patent Application Publication
(10) Pub. No.: US 2002/0017977 A1
(43) Pub. Date: Feb. 14, 2002

(54) Method and apparatus for licensing and controlling access, use, and viability of product utilizing geographic position

(76) Inventor: Mark Emanuel Wall, Fair Lawn, NJ (US)

Correspondence Address: FROMMER LAWRENCE & HAUG, 745 FIFTH AVENUE- 10TH FL., NEW YORK, NY, 10151, US

(21) Appl. No.: 09/921,968

(22) Filed: Aug. 3, 2001

Related U.S. Application Data
(60) Provisional application No. 60/222,981, filed on Aug. 4, 2000.
(60) Provisional application No. 60/250,969, filed on Dec. 4, 2000.

(51) Int. Cl. G05B 19/00; H04Q 1/00; G05B 23/00

(52) U.S. Cl. 340/5.28; 340/5.32; 340/825.49

(57) ABSTRACT

A method and system for controlling use of software and hardware, and for controlling access to and usability of commodities, by use of position (or location) dependent signals emanating from GPS, DPGS, GLONASS, and other sources, in conjunction with time and ephemeris data, wherein the receipt of position (or location) data is verified by reference to independent time and satellite ephemeris data, and where when position (or location) is established within preloaded boundaries, the system is rendered useful. A module which includes software and/or hardware modules (implemented as chip sets in combination with mechanical actuators), and a position (or location) determining system such as a global positioning receiver, built into each device and/or shipping container used to transport devices and/or commodities for control.

### RELATED APPLICATIONS

This application is based upon and claims priority from U.S. Provisional Application Nos. 60/222,981, filed Aug. 4, 2000, and 60/250,969, filed Dec. 4, 2000, which are incorporated herein by reference.

### FIELD OF THE INVENTION

The present invention relates to a method and apparatus for controlling access and operation of systems based on their geographical sites, their altitude, and the time of usage.

Each of the applications and patents cited in this text, as well as each document or reference cited in each of the applications and patents (including during the prosecution of each issued patent; “application cited documents”), and each of the PCT and foreign applications or patents corresponding to and/or claiming priority from any of these applications and patents, and each of the documents cited or referenced in each of the application cited documents, are hereby expressly incorporated herein by reference. More generally, documents or references are cited in this text, either in a Reference List before the claims, or in the text itself; and, each of these documents or references (“herein-cited references”), as well as each document or reference cited in each of the herein-cited references (including any manufacturer's specifications, instructions, etc.), is hereby expressly incorporated herein by reference.

### BACKGROUND OF THE INVENTION

Uses of global positioning systems (“GPSs”) to determine and control various processes have been in development. With respect to such systems, reference is made to the following:

Bush, U.S. Pat. No. 5,835,377, describes a method and system for optimized material movement within a computer-based manufacturing system utilizing global positioning systems.

Milender et al., U.S. Pat. No. 5,899,950, describes a sequential controller for off road vehicles in which a global positioning system is used to initiate control sequences based in part on vehicle location.

Rubin et al., U.S. Pat. No., 6,108,365, describes restrictions on viewing of live TV and other content signals delivered by a variety of media by location as well as region as determined by location from GPS reception.

Teare et al., U.S. Pat. No., 5,243,652, provides for transmission of a key to unlock programming content in remote and moving vehicles by reference to a history of positions (or locations) on the part of the remote station.

Long, U.S. Pat. No., 5,648,763, limits access to remote shipping containers by only permitting them to be opened at a specific location.

Each of these references provides a system for controlling and/or tracking a process using a positioning system. None of these patents, however, discloses or suggests a licensing, transportation control method and apparatus for controlling usage of system and/or commodities and for securing commodities in transit with time-based controls.

It has therefore been found desirable to design a licensing, transportation control method and apparatus with the advantages as noted below.

### SUMMARY OF THE INVENTION

The present invention was made to address the much broader need to control usage of systems and commodities once they have been shipped from their source to global destinations, and to do so in a manner which does not require active participation by a central controlling entity. In addition to control by virtue of position (or location), comparison with independent preloaded data as a function of time raises a barrier against spoofing the system, which can be made more robust depending on the value of the commodity being used and the likelihood of attempts to circumvent security. The use of the position (or location) as a security component for access to services and goods, and thereby for control of commodity condition and properties within a secure shipping container extends the capability for control to a wide range of applications. By making improper access to a remote container the cause of commodity destruction or alteration, security for high priced high markup goods and control of distribution of the same is made more effective. Further protection is provided for software and content by encrypted encoding of the location within the product.

It is an object of the invention to provide a method for assuring that a system, device or product will only operate or be useful within the geographical area designated for its use. Moreover, the present invention provides for active intervention when attempts are made to improperly gain access to or use the commodities protected. It also provides for the labeling of commodities with the licensed designation thereby providing a trace when unauthorized use of the product is detected. The technique employed uses a combination of GPS, differential GPS (“DGPS”), or other satellite differentiation of position (or location) with preset data, time, and independent transmission (with or without authentication) to control one or more actuators, in either hardware or software. The actuators are then used to control access to content, trigger changes in content both physical and software, produce changes in packaging, initiate processes which transform the product and otherwise exercise control over value and utilization based on user data, time and geographical location in three dimensions, geography and altitude. A corollary feature of the patent is the ability to control usage by time as well as position (or location) using the same basic GPS or other positioning network as an independent verifiable timing source.

To achieve the above-described and other advantages, a mechanism or process, which will allow the use and/or access to products and other shipping contents based on the location in four dimensions, geography, altitude, and time, of product and/or the product container is provided. This enables the shipment of product or technology for site-specific and time-specific usage. Consider the following scenarios:

Software, which once shipped to the user, is designed to be site specific or site licensed for any given interval.

Digital video or music distributed via the web or by hard copy designated for a specific purchaser. One could envision tiered pricing, for example selling for single site and/or limited time use at a much-reduced price.

An electronic or other appliance only usable in a given country (assures compliance with local regulations, for example)

Capital equipment such as construction equipment whose use is confined within specific geographic boundaries.

Military hardware limited to a specific theatre of usage. Consider a missile such as the Stinger which would only be operable within a battle zone and that could not be employed out of a certain area(s). In conjunction with active control, exercised over the same system of navigational or communications satellites, it is possible to exercise absolute control over remote systems delivered for any use.

Access to a widely available product, but only at a specific site for a specific shipment. The prime example is where we wish to price differently for different markets without shipments being diverted or smuggled from low price to high price areas. Prime examples are pharmaceuticals where we wish to price to local market but avoid a back channel into the higher priced supplier market.

All of the above limited by time as well as geography-the license expires after a prescribed interval of usage or is provided for predetermined periods.

In addition to allowing usage at the primary location, it may be required to allow varying degrees of portability for the license to use product. Temporary licensing away from the primary location for varying intervals may then be assigned either by passing the license on to activation using another identification tag (unique computer or interface identification such as Media Access Control (“MAC”) address, serial number, digital signature, or other unique device identification) in lieu of the actual primary location. For enabling critical systems such as those in use by military organizations, jamming detection in conjunction with motion detection and the basic positioning algorithms may be combined to avoid the ability to make systems inoperative by virtue of jamming navigational data transmission.

The invention may be used in combination with other security techniques such as digital certificates, imbedded equipment serial numbers, public key encryption and the like. For example, they may be used in combination for digital cellular technology. The location and time of use provides another important criteria for verification and licensing for many applications.

The primary method of location determination is through the use of GPS, DGPS, or other satellite positioning systems with worldwide coverage, such as Global Orbiting Navigation Satellite System (“GLONASS”), Communication satellites with shaped beams, and the like. The invention may make use of these same satellites or other alternate paths to transmit signals for active remote control over hardware and software systems of any sort.

In particular the present invention relates to a system which incorporates independent timing sources, satellite or other means of establishing precise locations by transmission to a receiver, pre-stored position (or location) and ephemeris data, and optional cryptographic and authentication procedures to assure that the systems will only operate within their pre assigned four dimensional space and are immune to spoofing or other unauthorized access. Additional protection against unauthorized use is provided by the addition of actuators, in hardware and software, which alter the nature of the delivered information or product so that further use is impossible. One distinction of the invention over any predecessor system is that it limits access to materials in open loop control that is acting in perpetuity on product already delivered. With the addition of site specific tagging, the source of bogus material can readily be identified to allow redress in the event of unauthorized decoding and replication.

There are wide varieties of software and hardware systems, which are licensed for use at specific sites. Licensing for use of these systems is usually effected through use of coded serial numbers, passwords issued by the manufacturer, reference to host serial numbers, etc. Until now, systems for licensing have not been directly tied to location. The ability to be location rather than hardware specific extends the licensing possibilities to a wide range of software, hardware, and non-electronic products.

Pricing of these systems as well as a wide range of commodities must often be adjusted to local economic conditions. It may be profitable for a company to adjust prices to local market conditions; a smaller profit may be acceptable to broaden the market to low-income areas. However, at the same time, the cheaper product must be kept from the high priced market to preserve the necessary margins for future research etc. Industries such as software and pharmaceuticals are prime examples where copyrights and patents protect large gross margins and where the incremental costs of production are extremely small.

A system which would limit the use of any commodity, manufactured item, or intellectual property to a pre-designated location or group of locations would greatly benefit the seller while at the same time making these items available at affordable prices in the local environment. The recent controversy over providing modern drugs to countries ill able to afford them points out the necessity for a system of the present invention. There are many other instances where products requiring large upfront investments are priced too high for many markets and where their sale at a lower price in those markets would greatly increase profitability for the manufacturer. Disparate pricing between elastic and inelastic markets has been dealt with by economists within the body of “Ramsey Theory.” An embodiment of the present invention provides a mechanism for implementing these pricing policies by assuring site and time limited usage.

Many other benefits may be obtained with respect to limiting usage to specific geographic areas and/or time. Content and software, which is made available for limited geographic and time usage, extends the control of the provider to the end user, making the provision of goods and services akin to leasing. The major issue is retention of control by the provider after sale, which opens up a vast array of opportunities for the commercial provision of content on an as needed basis, without fear of copying for unauthorized use. Although systems have been proposed for limiting access to broadcast and other delivered information, this invention alters the state of the delivered object in such a manner as to make it permanently unsuited for use at other than a licensed location.

A preferred embodiment of a system in accordance with the present invention for software control provides for an interface between a GPS receiver and computers/controllers using specific software. At time of purchase, (or as part of a preset shipment) position (or location) data is entered, which specifies the reference location and the permissible limits (in three dimensions and time) over which the software may be used. Delineation may be provided at the time of purchase or contract (if required by the manufacturer), by allowing the users to enter data on their address from the web. The receiver is provided with an interface, which provides current position (or location) data to the computer along with any other data deemed necessary for security, e.g. the specific satellites from which the data was derived. The software package makes a comparison between current position (or location) and area of operability and either allows operation directly or sets a license interval during which the process must be repeated to extend the license.

In accordance with an embodiment of the invention, position (or location) data may be compared against the preset position (or location) as entered by the controlling authority. The position (or location) may be defined three dimensionally, incorporating altitude, and additional restraints of time may be included. Satellite ephemeris data coupled with time adds security by comparing the satellites used for position (or location) and time against those predicted by ephemeris data preloaded into the control mechanism. Additional levels of security may be added using a variety of techniques, many of which will be detailed below. The license to use is then effected by providing the position (or location) data as a critical element of a secure code for access, the same position (or location) data having been used to generate a secure code protecting the device at the controlling entity.

In accordance with another embodiment, software Dynamic Link Libraries (“DLLs”) necessary for operation can be erased unless timely position (or location) data is input. The vendor can then be contacted via the Internet to reinstall the DLL for a limited time.

In another embodiment of the invention, licenses may be extended from one location to another and controlled for transportable use. In this case, a “token” may be sent to the party wishing to employ software beyond the originally negotiated range. A limited time use license may then be granted for that current location. The possible variations are manifold, providing means whereby a licensee may allow offsite use of software or hardware as well as means for an individual to change location for an installed copy on a temporary basis. One example transfers the license to a computer MAC address or serial number for use at other than the primary location until such time as it is determined that the new location must also be allowed. Another variant has the ability to incorporate multiple addresses by using the base address information as a factor in generating a security code for the controlled element. Licenses may be granted to one or several locations based on need and for different contract prices.

Yet another embodiment of the invention for portable control may be to require that the host mechanism be returned to a valid position (or location) on a periodic basis. For example, a computer may be licensed for use at home and office. It may be required to be at one of those sites in any 30-day period for it to remain operable. Appropriate warnings may be issued to the user and provision can be made for extensions, etc., to avoid inconvenience in the case of legitimate needs for extension.

Still another embodiment of the invention may be designed to protect information downloaded from the web or sold on compact disc (“CD”) and digital video disc (“DVD”) or other storage device as digital information. In this instance, a noise like signal may be encoded using the position (or location) data (for example summed using modified modulo arithmetic with a pseudorandom sequence). On the web, the signal, which may be unique for each location requesting a copy, is inserted at the time of purchase. Dealer insertion on distributed hard copy is also a possibility at time of purchase. A GPS receiver produces a validated position (or location), which is then used at the target site to decode and restore the signal to its original quality. It is possible using this technique to degrade the signal only slightly, for example to analog quality, reducing its quality away from the designated site but still leaving it usable for demonstration purposes. The degree and method chosen is flexible and depends on marketing considerations.

Another embodiment of the invention for controlling downloaded software or other digital information may utilize “cookies” within the web browser to incorporate position (or location) data when accessing web sites to obtain electronic product. The GPS receiver chip set produces position (or location) and relevant satellite data for confirmation and causes this to be updated within the browser such that relevant user information (validated position (or location) primarily) is forwarded to the vendor at the time of request.

A further embodiment of the invention may use the technique to validate delivered data. Thus, for example, when forwarding fax messages, a check is made to ensure that the physical information is being delivered to the indicated geographic location.

Still a further embodiment of the invention may provide for controlling a plurality of outputs by using a manufactured device consisting of a chip set containing processor logic and capable of storing ephemeris data for satellites that serve the geographic area in which the licensed site resides. The manufactured device may use a clock deriving time from GPS to point to the appropriate data for the time and geographic area receiving satellite data. The output from a GPS receiver may be used to indicate the position (or location) and satellite sources used in determination. If the position (or location) is correct (within allowable error or range) and the sources correspond to those expected at the time of reading, the actuator(s) are enabled by appropriate outputs. The actuators may then be used directly to affect the desired control or may be used to reset a timer, which keeps the device in a desired state until the next position (or location) is taken later. Upon expiration of the timer without another validated position (or location) reading, positive or negative actions with respect to the controlled element, commodity, or software may be taken.

Another embodiment of the invention may employ jamming detection when position (or location) signals are not adequate. An acceptable last fix in conjunction with jamming may be used as a system enabler in lieu of a positive fix for some applications.

Still another embodiment of the invention may use motion detectors in conjunction with the last fix to extend licenses in the absence of usable positioning signals. Combining this with jamming detection, all three components may be used to extend licenses in the presence of hostile environments. Use of all three techniques in combination is proposed to enhance availability and robustness of system use in critical applications.

Yet another embodiment of the invention may keep track of the position (or location) of the device containing licensed product. As long as the device has “visited” the licensed site within a controlled interval the license is active. This permits licenses to be carried portably as long as the user passes a designated home base on a periodic basis. Thus, a range of devices, portable CD players, laptop computers and the like, may all be licensed for use by virtue of having visited the reference location. For more permanent moves provision can be made for registering additional addresses within the licensed device. Islands of use may then be established. In the event of a permanent move of primary location, the provider may be contacted to effect a permanent transition to a new base location, which then becomes the new reference location.

Another embodiment of the invention may use a satellite with shaped beams designed for specified geographical coverage. Signals sent to the specific area cause the actuators to be enabled. Signals may be encoded with a time sensitive code only enabling decoding at the target site at a specific time. Since the satellite transmission is received at a known time at the target, retransmission for decoding will add the retransmission time so that the time sensitive code can no longer be used in decoding to control actuators. It then becomes impossible to spoof the system by relaying raw data to another part of the world for decoding when keys or digital certificates have been compromised.

In accordance with an embodiment of the invention, the actuators controlled by any of the above techniques may be used to control delivered product shelf life. Absence of the proper geographic input for more then the reset interval may allow the actuator to operate to prohibit an authorized use. The following means of controlling product may be included, inter alia:

The commodity is destroyed or contaminated through release of an agent in the packing container.

One technique for altering properties of pharmaceuticals is to use a binder for pills that deteriorates upon contact with the atmosphere in a given interval of time. Pills would then disintegrate to powder rendering the compound still usable in emergencies but unsaleable in higher priced markets. In one preferred implementation, packing cases would have a specific retardant atmosphere keeping the item fresh with a pressurized canister of activating atmosphere to be released in the absence of a signal within allotted intervals.

An agent could be released to discolor product or labeling to inhibit sale in upscale markets while retaining basic utility in lower priced markets. The type and operation could vary from container to container so that any breach would be unpredictable, e.g. release of a gas in one case and exposure to atmosphere in another, each requiring a different countermeasure on the part of unauthorized users.

An expiration date can be set on the package, which renders the product not saleable beyond the date.

A substance may be released causing product to adhere (in the case of pills for example). This same technique could be used for a benign modification—if product is appropriately repackaged at the point of delivery, the shelf life is extended; if not, the product deteriorates. There is little economic burden in forcing added effort in low priced labor environments while the fact of repackaging can itself make the product unsuitable for sale in non-elastic market through a variety of techniques.

Another embodiment of the invention may use the GPS chipset to continuously track the position (or location) of the shipment and compare it against a preloaded route for the shipment. Either independently or in conjunction with a cellular chipset, deviations from the planned route may be made to effect changes in the shipment, diminishing value to a highjacker. This is mostly useful where there is extensive value added to a low manufacture cost good.

Still a further embodiment of the invention allows multiple releases of individual consignments within a shipment on a timed basis. The product then may be allocated as a product stream as follows:

Release of the first consignment sets a clock for release of the next;

When the clock has reached the allowed interval, the second consignment release is enabled, and another clock set is enabled for the third consignment;

The process continues for the subsequent consignments as necessary;

Product altering mechanisms at each stage may be common or varied depending on the dictates of the application.

Yet another embodiment of the invention may use GPS in connection with security features to limit operability of major equipment to designated areas. Uses for this feature may include, inter alia:

Limiting use of munitions to a circumscribed theatre

Limiting use of construction equipment to a specific site

Limiting vehicle use to a specific geography

Limiting any equipment use to a specifically circumscribed area

Another embodiment of the invention may use the satellites used for positioning information as direct conduits of active control data. Enabling or other control information may be sent by modulating position (or location) information or via a separate channel in the case of communications satellites. Position (or location) may be used along with other cryptographic techniques to secure control data. Another embodiment would use site specific decoding of broadcast material limiting its use to the geography for which it is intended by degrading utility of product, adding a controlled amount of signal degradation that can only be removed when the content is at a specific location(s).

Still another embodiment of the present invention may use transmitted authentication to a specific user of a product when located at specified geographical coordinates. The authentication signals may be constructed to incorporate position (or location) and time to prevent unauthorized decoding and thereby use of the commodity at other than specified locations. The license to use can be further limited to specified time intervals establishing positive control for copyright administration.

Still another embodiment of the present invention may include a cellular communication chip set capable of global satellite communication. A central control location can query the controlled object, obtaining its position (or location), and then exercise remote control of actuators for purposes of denying or granting access, allowing use, or causing changes to content of containers.

In summary, the following unique aspects of the invention may be delineated, inter alia, as representative of new and unique features of the invention:

Use of geographic position (or location), altitude above sea level, and time to license or otherwise control usage and/or access to content of delivered product, post delivery, for the life of the product.

Independent verification of position (or location) by reference to time and satellite ephemeris data transmitted along with the product sold.

No requirement for recipient action for many applications; preloaded position (or location) and ephemeris data are sufficient to effect control.

Positive reinforcement of position (or location) required to keep delivered product operational or viable.

Control can be independent of any source or can be returned to a central control station using a cellular chipset for bi-directional command and control.

Control can be effected by use of positioning satellites to carry specific coded data.

Combined use ofjamming detection and motion sensing to bridge periods where a positive fix is masked.

Extended control capability by allowing pass through visits to a base site for license renewal or extension.

The invention accordingly comprises the several steps and the relation of one or more of such steps with respect to each of the others, and the apparatus embodying features of construction, combination(s) of elements and arrangement of parts that are adapted to effect such steps, all as exemplified in the following detailed disclosure, and the scope of the invention may be indicated in the claims.

In this disclosure, “comprises”, “comprising,” and the like have the meaning ascribed to them in U.S. Patent law and mean “includes,” “including,” and the like.

These and other objects and embodiments of the invention are provided in, or are obvious from, the following detailed description.

### BRIEF DESCRIPTION OF THE DRAWINGS

The invention, as well as preferred modes of usage, advantages and objectives, is best understood by reference to the following description of illustrative embodiments when read in conjunction with the accompanying figures outlined below.

FIG. 1 is a block diagram showing basic elements of a geographic access and usage control system for control of delivered software in accordance with an embodiment of the invention;

FIG. 2 is a block diagram showing elements of a geographic access and usage control system for protecting content for sale over the web or by other electronic means in accordance with a embodiment of the invention;

FIG. 3 shows elements of a self-contained control device for confining operation of a delivered device to a pre-specified geographic domain and/or control access to a container, changing the characteristics of its contents by physical or chemical means, or changing markings on the container and/or physical contents according to an embodiment of the invention;

FIG. 4 shows the use of shaped beam satellite transmission systems to direct controlling transmissions to specified regions, where by incorporation of time sensitive coding, relaying of the transmission to non-target sites for unauthorized access is prohibited, in accordance with an embodiment of the invention; and

FIG. 5 is a block diagram illustrating a process of controlling usage and/or access according to preset parameters in accordance with an embodiment of the invention.

### DETAILED DESCRIPTION OF THE PREFERRED EMBODIMENTS

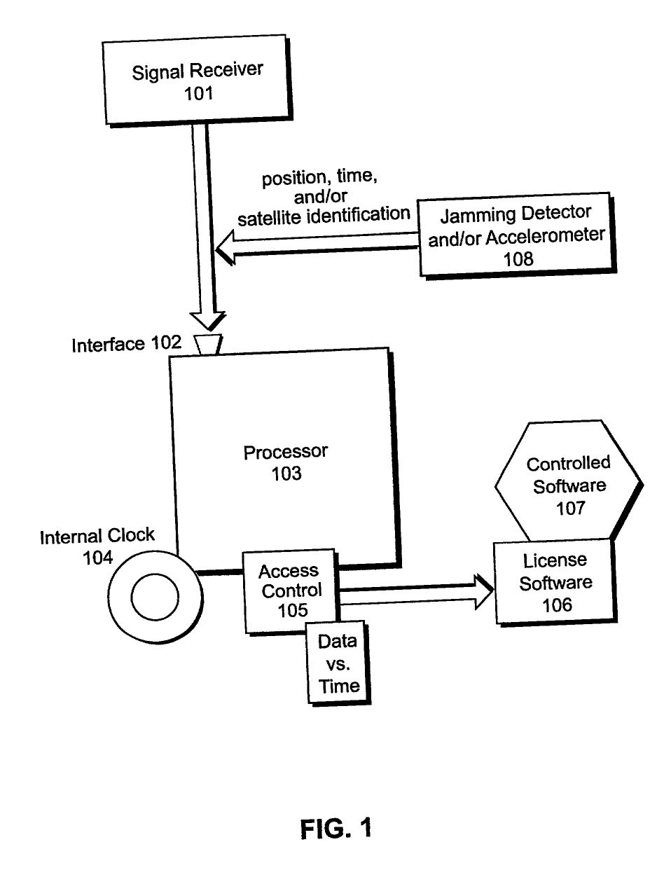

Referring to FIG. 1, a system for limiting use of delivered software to one or more specific sites according to an embodiment of this invention, is shown. In this embodiment, a software utility is provided to perform required comparative functions and produce the required license key permitting the software to operate.

A signal receiver 101 (e.g., a GPS or other global positioning system, such as GLONASS, receiver) may be a chip set including all the position (or location) and time determination functionality. Such a chip set may be the size of a postage stamp and contain full functionality.

Signal receiver 101 can be put into various form factors, such as a computer card or printed circuit addition to a video or CD player, and can operate continuously by sending position (or location), time, and/or satellite data to an interface 102, which may be a specially designed Universal Serial Bus (“USB”) port. Interface 102 and receiver 101 may be required to be operational to allow the software to be operated either currently or during the time that a license extension is necessary. Receiver 101 and interface 102 may be combined into a single computer card although an antenna for receiver 101 may remain external.

At the time of software purchase and/or installation, a purchaser may indicate one or more locations by entering the geographical coordinates of the site(s) at which the software will be used. This may be accomplished by lookup of data corresponding to the address of the purchaser, or taken from an actual GPS reading that produces position (or location) and altitude for reference. The purchaser location information may be stored as part of an installed software access control component (105) along with any authentication data desired to provide additional security. During installation, a provider website may be contacted for required data associated with the purchaser location. This may consist of a list of GPS satellites as a function of time that are acceptable as sources for position (or location) data. If it is assumed that five satellites are in 15-minute increments, one-year of position (or location) data will approximately be 40 Kbytes of data. This data is forwarded as part of the purchased software and stored for reference within a processor 103 (which may be any computing device) or a separate memory (not shown).

The access control software may continuously read the geographic position (or location) and check its validity by determining the satellites used based on the time of comparison. Under normal conditions, there will be a match in position (or location) and the software remains enabled.

One proposed method is to have a limited term license granted within a license software component (106) corresponding to the maximum permitted time between verifications. Alternatively, limited time licenses may be granted for specific purposes as a technique for making product available.

If the geographic coordinates match within specified limits, the license is refreshed for the specified interval and controlled software (107) is rendered operational. Any method for allowing operation is acceptable and does not affect the basic method of site licensing by verifying geographic location

Any mismatch may result in a lack of ability to reset licensing intervals or result directly in shutdown of the software, requiring the user to contact the supplier for reinstatement. A wide range of scenarios may be implemented which ensure continued operation for critical applications, allowing a reasonable time to rectify errors if these occur. These include, inter alia, warnings of expiration, extensions until a different fix is detected, remote reporting and subsequent investigation prior to shutdown.

Accelerometer(s), and/or jamming detector(s) (108) may be provided to detect and track motion of a purchaser device or the presence of jamming signals. This feature may be used to back up GPS position (or location) information from receiver 101 when there is signal insufficiency. Detection of excessive displacement may be used to indicate the need for a new position (or location) fix to the user device, or to shut down the system pending new position (or location) determination for critical applications. Jamming detection can be used to extend or otherwise modify the license until proper signals are once again available.

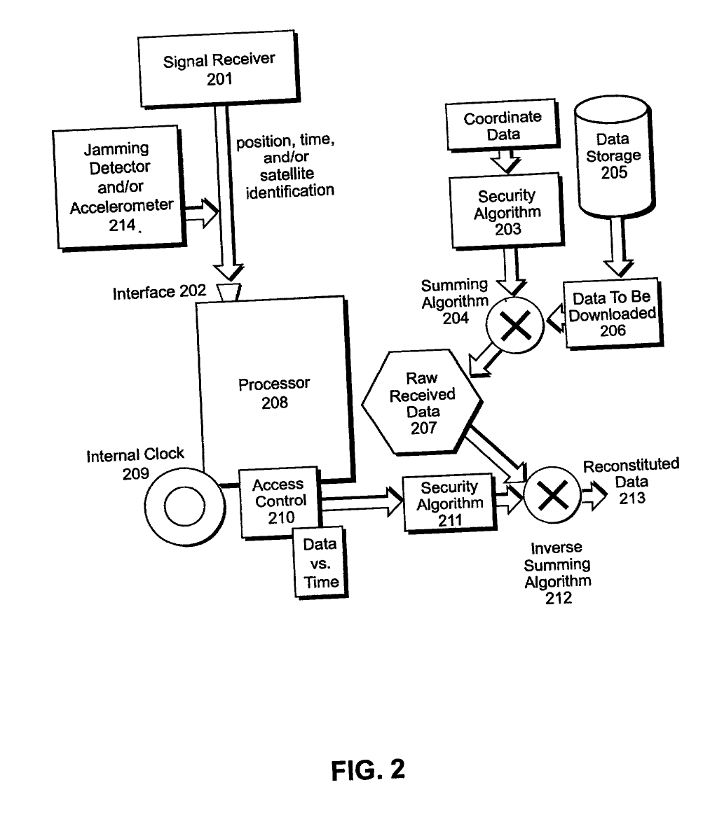

FIG. 2 is a block diagram showing a method for limiting access to material downloaded from a web site in accordance with an embodiment of the invention. When potential users order data from a supplier, they are requested to input their address or automatically input information from a GPS receiver (which may be signal receiver 201). The supplier then uses the geographical coordinates as a factor in generating a code using a security algorithm (203) as shown. The resulting signal is summed with the data, using a summing algorithm (204) designed to introduce a measured amount of degradation when downloaded, rendering it less useful than if uncorrupted. It is possible with analog signals to introduce varying degrees of distortion depending on the application.

At a receiving processor (computer) 208, a position (GPS) signal from a receiver (201) is authenticated using an internal clock (209) and ephemeris data downloaded from the website. The local position (or location) data is used with a receive security algorithm (211) at the receive site to subtract, using an inverse summing algorithm (212), the corrupting signal from that sent (raw received data 207), providing reconstituted data for use at the target site (213).

It is preferable to couple the reconstituting algorithm with an actual playback device (not shown) for playing back reconstituted data 213 but a wide range of options can be considered based on risk assessment and cost. The addition of accelerometers (214) can provide an indication of departure from base in the event that position (GPS) signals are not available for any interval of time. Here, as in FIG. 1, the movement can be used to trigger a request for a new fix.

Another feature that can be incorporated would permit the tracing of content software that somehow was distributed improperly. It may be presumed that with enough time and resources, any code can be broken and the uncorrupted digital output could be made available. By superimposing coded position (or location) data on content data at extremely low frequency and low level, a tracer for the source of improperly distributed information may be incorporated into data. An unauthorized copy may then pinpoint its source so that investigation may proceed.

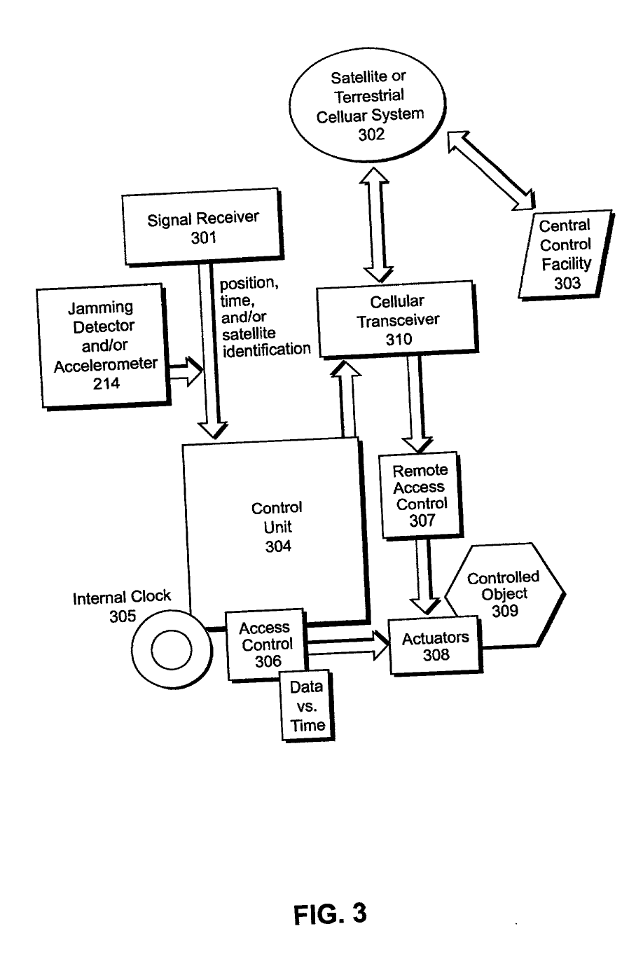

FIG. 3 is a block diagram that shows a system for controlling access or use of a hardware device to a given geographic location in accordance with an embodiment of the invention. Also shown is the option for remote monitoring of validated position (or location) through use of cellular communications, preferably satellite cellular, and exercising control over access or state from a remote control location. As shown in FIG. 3, a (GPS) receiver (301) feeds position (or location), time, and/or satellite ID to an intelligent controller (304), which may include a processor. Controller 304 may include internal clock (305), local access control (306), containing storage capable of holding satellite ID as a function of time in 15-minute increments (adjustable depending on the degree of security required), and circuitry (not shown) necessary to validate position (or location) and time data from (GPS) receiver 301. The acceptable geographic range of operation may be programmed into controller 304 by a purveyor of a hardware device upon receiving an order. Comparison of GPS data against that stored either inhibits or sets an actuator(s) (308) which controls system operation. There are many variants on the precise technique for allowing system operation including resetting a license timer. These may be chosen based on the needs for operation when suitable signals are not available.

Also shown in FIG. 3 is a system for remote monitoring and control of the controlled object (309). In this case, position (or location) and satellite data is communicated to a central control facility (303). The facility 303 may poll the control unit 304 using a cellular system 302, or the information may be sent on a periodic basis. Control signals are then sent by the central control facility 303 via either terrestrial or satellite cellular systems (302), and are received by a cellular receiver chip set (not shown), processed by remote access control, and used to drive appropriate actuators 308 to get desired results.

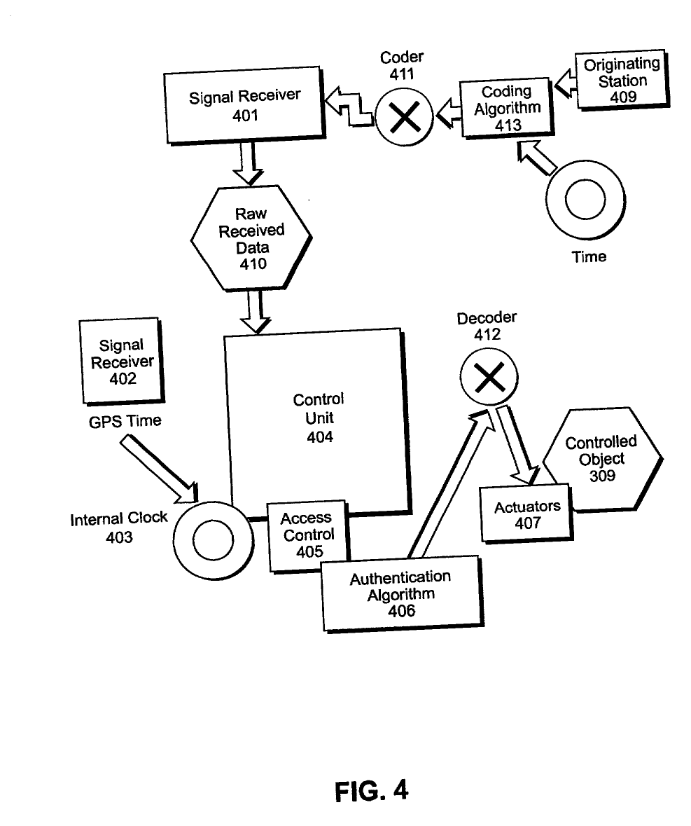

FIG. 4 shows a system for using shaped beam satellite transmission in lieu of GPS or other global positioning system such as GLONASS according to an embodiment of the invention. This system has applicability where it is desired to limit access or utility to a region rather than a specific location. The system receives data for the region that is uniquely encoded using an algorithm encompassing code identifying the location for which the use is intended. Included in the algorithm may be a precise time of receipt. This is critical to avoid spoofing by relaying the signal to another location that can decode by obtaining necessary authentication data via corruption or other means. By ensuring that the coded signal is only usable at a precise time, relaying it to another location will add a delay, which would mean that the received signal no longer tracks absolute time and cannot be decoded. All of the previous functionality is then executed based on shaped beam differentiation ensuring that signals are receivable only at the target location at the time specified for decoding.

A receiver (401) receives a signal, which is isolated to the region of interest using a shaped satellite beam. Those familiar with the art will know that shaped beams are commonly used in satellite systems to concentrate energy to a target region and permit reuse of transmission frequencies where possible. A signal from an originating station 409 is encoded using a time based coding algorithm (413), by a coder (411) to yield the signal to be transmitted using shaped beams. The (satellite) receiver 401 only receives usable signals if within the geographic area covered by the shaped beam.

Raw received data 410 is processed by the control unit chip set (404) assembling local time as determined by a receiver (say, a GPS chip set) 402 calibrating an internal clock (403) in conjunction with an authentication algorithm (406) dependent on precise time to generate sequences used by the decoder (412). Successfully decoded signals are then used to drive actuators 407 for control of designated objects 309.

Thus, signals sent to a specific area cause actuators 407 to be enabled only if receiver 401 is in position (or location) to receiver the signals. Signals may also be encoded with a time sensitive code only enabling decoding at the target site at a specific time, i.e., only if internal clock 403 forwards the specific time to decoder 412. Since the satellite transmission is received at a known time at the target, retransmission for decoding will add the retransmission time so that the time sensitive code can no longer be used in decoding to control actuators. It then becomes impossible to spoof the system by relaying raw data to another part of the world for decoding when keys or digital certificates have been compromised.

It is noted that receivers 401 and 402 may be incorporated into one element for performing both of their respective functions described above.

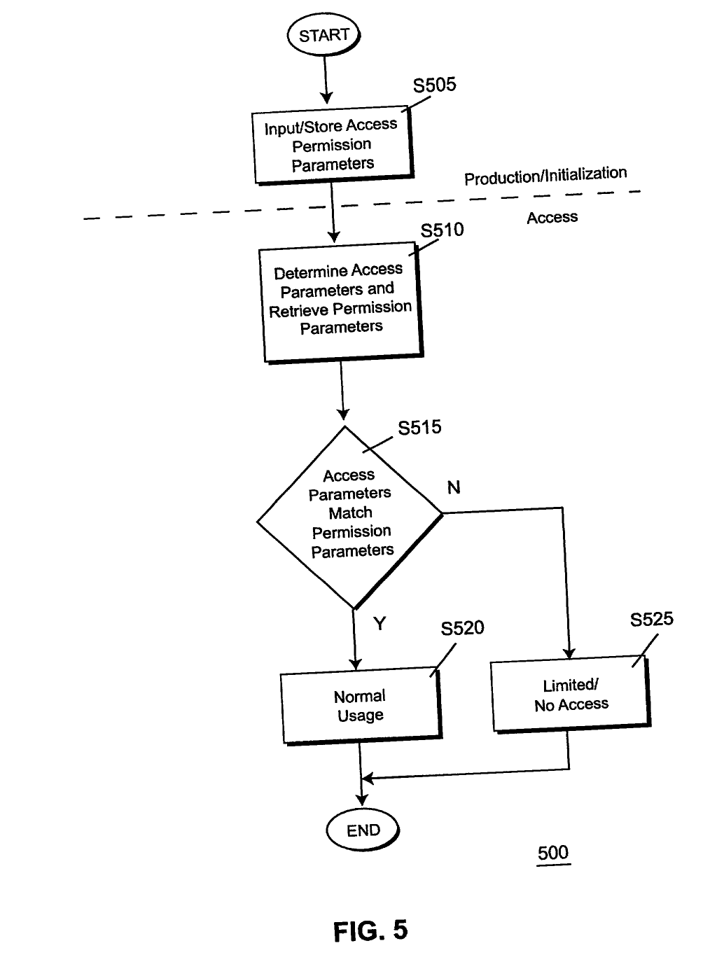

FIG. 5 illustrates a process 500 of controlling/limiting access and/or usage of a system and/or commodity according to preset parameters in accordance with an embodiment of the invention. It is noted that process 500 may be implemented to any of the systems illustrated in FIGS. 1-4 with or without variation. As an example, any step of process 500 may be part of a software program executed by processor 103, 208, 304, and 404. As shown in FIG. 5, process 500 begins with step s505 where access/usage permission parameters may be input, stored, or programmed to a memory of a control system. Such permission parameters may include geographic location where controlled software is permitted to be used or where controlled commodity is allowed to be accessed, time at which such access/usage is permitted, etc. Step s505 may be performed as an initialization or production step of a software system, a commodity delivery system, etc. (i.e., before the system leaves a production facility). It may also be a subscription initialization or updating step at an already authorized site, such as a primary location for software use.

Next, when the software system, commodity, etc. is used or accessed (or during access/usage), at step s510, access/usage parameters of the software system, commodity delivery system, etc. are determined and the stored permission parameters are retrieved from memory. The access/usage parameters may be determined by receiving GPS signals to determine a current geographic location, an internal or external clock to determine a current time, etc.

It is then determined, at step s515, whether the (“current”) access/usage parameters match the (“pre-stored”) permission parameters. If the parameters match (“Y”), process 500 allows normal access/usage of the controlled system/commodity, as shown by step s520. If the parameters do not match (“N”), process 500 may prohibit or limit the access/usage, as shown by step s525.

As described before, process 500 may be implemented to any of the systems shown in FIGS. 1-4.

For example, process 500 may be implemented to the system of FIG. 1 for software control that includes interface 102 between receiver 101 and processor 103 (computers/controllers) using specific software. At time of purchase, (or as part of a preset shipment) position (or location) data is entered at step s505 of process 500, which specifies the reference location and the permissible limits (in three dimensions and time) over which the software may be used (access/usage permission parameters). Delineation may be provided at the time of purchase or contract (if required by the manufacturer), by allowing the users to enter data on their address from the web. Receiver 101 is provided with interface 102, which provides current position (or location) data to processor 103 along with any other data deemed necessary for security, e.g. the specific satellites from which the data was derived, i.e. access/usage parameters, at step s510. The software package makes a comparison, at step s515, between current position (or location) (access/usage parameters) and area of operability (permission parameters), and either allows operation directly and/or sets a license interval during which process 500 must be repeated to extend the license (at, say, step s520).

Process 500 may also be implemented for a number of different applications in accordance with respective embodiments of the invention (with or without modification). Implementation of process 500 to some of these embodiments will now be described.

Temporary licensing away from a primary location for software use in varying intervals may be assigned as step s505. In such a system, step s505 may be implemented either by passing a license on to activation using another identification tag (unique computer or interface identification such as Media Access Control (“MAC”) address, serial number, digital signature, or other unique device identification) in lieu of the primary location.

For enabling critical systems, jamming detection in conjunction with motion detection and the basic positioning algorithms may be combined to step s510 and/or s515, in determining whether permission parameters have been met, to avoid the ability to make systems inoperative by virtue of jamming navigational data transmission. Process 500 may be used in combination with other security techniques such as digital certificates, imbedded equipment serial numbers, public key encryption and the like. For example, they may be used in combination for digital cellular technology. The location and time of use provides another important criteria for verification and licensing for many applications.

As described before, a primary method of location determination is through the use of GPS or other satellite positioning systems with worldwide coverage, such as GLONASS, Communication satellites with shaped beams, and the like. These same satellites or other alternate paths may also be used to transmit signals for active remote control over hardware and software systems of any sort.

Process 500 may incorporate independent timing sources, satellite or other means of establishing precise locations (access/usage parameters) by transmission to a receiver, pre-stored position (or location) and ephemeris data, and optional cryptographic and authentication procedures to assure that the systems will only operate within their pre assigned four dimensional space (permission parameters) and are immune to spoofing or other unauthorized access. Additional protection against unauthorized use may be provided by the addition of actuators, in hardware and software, (which are activated at, say, step s525 of process 500) for altering the nature of the delivered information or product so that further use is impossible.

Process 500 for control may be executed on an open loop, acting in perpetuity on product already delivered. For example, steps s510 and s515 may be executed each time usage is initiated or on a regular-timed basis. With the addition of site specific tagging, the source of bogus material can readily be identified to allow redress in the event of unauthorized decoding and replication.

Process 500 may be implemented to limit the use of any commodity, manufactured item, or intellectual property to a pre-designated location or group of locations, which would greatly benefit a seller while at the same time making these items available at affordable prices in the local environment. The recent controversy over providing modem drugs to countries ill able to afford them points out the necessity for a system of the present invention. There are many other instances where products requiring large upfront investments are priced too high for many markets and where their sale at a lower price in those markets would greatly increase profitability for the manufacturer. Disparate pricing between elastic and inelastic markets has been dealt with by economists within the body of “Ramsey Theory”. Thus, process 500 may be used for implementing these pricing policies by assuring site and time limited usage.

Many other benefits may be obtained with respect to limiting usage to specific geographic areas and/or time. Content and software, which is made available for limited geographic and time usage, extends the control of the provider to the end user, making the provision of goods and services akin to leasing. The major issue is retention of control by the provider after sale, which opens up a vast array of opportunities for the commercial provision of content on an as needed basis, without fear of copying for unauthorized use. For example, step s525 of process 500 may include altering a state of a delivered object in such a manner as to make it permanently unsuited for use at other than a licensed location.

In accordance with an embodiment of the invention, access/usage parameters may include position (or location) data that is compared (at step s515 of process 500) against permission parameters that include a preset position (or location) as entered by the controlling authority. A “usage” position (or location) may be defined three dimensionally, incorporating altitude, and additional restraints of time may be included. Satellite ephemeris data coupled with time adds security by comparing the satellites used for position (or location) and time against those predicted by ephemeris data preloaded into the control mechanism. Additional levels of security may be added using a variety of techniques, many of which will be detailed below. The license to use is then effected by providing the position (or location) data as a critical element of a secure code for access, the same position (or location) data having been used to generate a secure code protecting the device at the controlling entity.

In accordance with another embodiment, software Dynamic Link Libraries (“DLLs”) necessary for operation can be erased (at, say, step s525) unless timely position (or location) data is input. The vendor can then be contacted via the Internet to reinstall the DLL for a limited time.

In another embodiment of the invention, licenses may be extended from one location to another and controlled for transportable use. In this case, a “token” (of permission parameters) may be sent to the party wishing to employ software beyond the originally negotiated range. A limited time use license may then be granted for that current location. The possible variations are manifold, providing means whereby a licensee may allow offsite use of software or hardware as well as means for an individual to change location (permission parameters) for an installed copy on a temporary basis. One example transfers the license to a computer MAC address or serial number for use at other than the primary location until such time as it is determined that the new location must also be allowed. Another variant has the ability to incorporate multiple addresses by using the base address information as a factor in generating a security code for the controlled element. Licenses may be granted to one or several locations based on need and for different contract prices.

Yet another embodiment of the invention for portable control may be to require that the host mechanism be returned to a valid position (or location) (for steps s510 and s515 of process 500) on a periodic basis. For example, a computer may be licensed for use at home and office. It may be required to be at one of those sites in any 30-day period for it to remain operable. Appropriate warnings may be issued to the user and provision can be made for extensions, etc., to avoid inconvenience in the case of legitimate needs for extension.

Still another embodiment of the invention may be designed to protect information downloaded from the web or sold on CD and DVD or other storage device as digital information. In this instance, a noise like signal may be encoded using the position (or location) data (for example summed using modified modulo arithmetic with a pseudorandom sequence). On the web, the signal, which may be unique for each location requesting a copy (thus forming permission parameters for using the information), is inserted at the time of purchase. Dealer insertion on distributed hard copy is also a possibility at time of purchase. A GPS receiver (say, receiver 101 of FIG. 1) produces a validated position (or location) (access/usage parameters), which is then used at the target site to decode and restore the signal to its original quality (step s515 of process 500). It is possible using this technique to degrade the signal only slightly, for example to analog quality, reducing its quality away from the designated site but still leaving it usable for demonstration purposes (i.e., step s525 limited usage of process 500). The degree and method chosen is flexible and depends on marketing considerations.

In another embodiment of the invention, process 500 may be used to keep track of one or more position(s) (or location(s)) of a device containing licensed product. As long as the device has “visited” the licensed site within a controlled interval (access/usage parameters) the license is active. This permits licenses to be carried portably as long as the user passes a designated home base on a periodic basis (where permission parameters include such a requirement). Thus, a range of devices, portable CD players, laptop computers and the like, may all be licensed for use by virtue of having visited the reference location. For more permanent moves provision can be made for registering additional addresses within the licensed device. Islands of use may then be established. In the event of a permanent move of primary location, the provider may be contacted to effect a permanent transition to a new base location, which then becomes the new reference location.

In accordance with an embodiment of the invention, step s525 of process 500 may include activating actuators used to control delivered product shelf life. For example, absence of the proper geographic input for more than a reset interval (step s515) may allow the actuator to operate to prohibit normal use. Thus, step s525 may include inter alia:

destroying or contaminating a commodity in transit through release of an agent in a packing container

altering properties of pharmaceuticals by using a binder for pills that deteriorate upon contact with the atmosphere in a given interval of time (Pills would then disintegrate to powder rendering the compound still usable in emergencies but unsaleable in higher priced markets. In one preferred implementation, packing cases would have a specific retardant atmosphere keeping the item fresh with a pressurized canister of activating atmosphere to be released in the absence of a signal within allotted intervals.)

releasing an agent to discolor product or labeling to inhibit sale in upscale markets while retaining basic utility in lower priced markets (The type and operation could vary from container to container so that any breach would be unpredictable e.g. release of a gas in one case and exposure to atmosphere in another, each requiring a different countermeasure on the part of unauthorized users.)

releasing a substance causing product to adhere (In the case of pills for example. This same technique could be used for a benign modification—if product is appropriately repackaged at the point of delivery, the shelf life is extended; if not, the product deteriorates. There is little economic burden in forcing added effort in low priced labor environments while the fact of repackaging can itself make the product unsuitable for sale in non elastic market through a variety of techniques).

Another embodiment of the invention may use a position (or location) (GPS) signal (from, say, receiver 101, 201, 301, or 401) to continuously track the position (or location) of a shipment (access/usage parameters) and compare it against a preloaded route for the shipment (permission parameters)(either independently or in conjunction with a cellular chipset). Deviations from a planned route may be made to effect changes in the shipment, diminishing value to a highjacker. This is mostly useful where there is extensive value added to a low manufacture cost good.

Still a further embodiment of the invention allows multiple releases of individual consignments within a shipment on a timed basis (i.e., permission parameters may be dynamically set and/or altered at, say, step s520 of process 500). The product then may be allocated as a product stream as follows.

Release of the first consignment sets a clock for release of the next

When the clock has reached the allowed interval, the second consignment release is enabled, and another clock set is enabled for the third consignment

The process continues for the subsequent consignments as necessary

Product altering mechanisms at each stage may be common or varied depending on the dictates of the application

Yet another embodiment of the invention may use current position information (GPS) in connection with security features to limit operability of major equipment to designated areas. Uses for this feature may include inter alia:

Limiting use of munitions to a circumscribed theatre

Limiting use of construction equipment to a specific site

Limiting vehicle use to a specific geography

Limiting any equipment use to specifically circumscribed area

Another embodiment of the invention may use the satellites used for positioning information as direct conduits of active control data. Enabling or other control information may be sent by modulating position (or location) information or via a separate channel in the case of communications satellites. Position (or location) may be used along with other cryptographic techniques to secure control data. Another embodiment would use site specific decoding of broadcast material limiting its use to the geography for which it is intended by degrading utility of product, adding a controlled amount of signal degradation that can only be removed when the content is at a specific location(s).

Still another embodiment of the present invention may use transmitted authentication to a specific user of a product when located at specified geographical coordinates. The authentication signals may be constructed to incorporate position (or location) and time to prevent unauthorized decoding and thereby use of the commodity at other than specified locations. The license to use can be further limited to specified time intervals establishing positive control for copyright administration.

Still another embodiment of the present invention may include a cellular communication chip set capable of global satellite communication. A central control location can query the controlled object, obtaining its position (or location), and then exercise remote control of actuators for purposes of denying or granting access, allowing use, or causing changes to content of containers.

Another embodiment of the invention for controlling downloaded software or other digital information may utilize “cookies” within the web browser to incorporate position (or location) data (access/usage parameters) when accessing web sites to obtain electronic product. The GPS receiver chip set (e.g., receiver 101 of FIG. 1) produces position (or location) and relevant satellite data for confirmation (by comparing access/usage parameters to centrally stored permission parameters as step s515) and causes this to be updated within the browser such that relevant user information (validated position (or location) primarily) is forwarded to the vendor at the time of request.

A further embodiment of the invention may use process 500 to validate delivered data. Thus, for example, when forwarding fax messages, a check (e.g., step s515) is made to ensure that the physical information is being delivered to the indicated geographic location.

Still a further embodiment of the invention may provide for controlling a plurality of outputs by using a manufactured device consisting of a chip set containing processor logic and capable of storing ephemeris data for satellites that serve a geographic area in which the licensed site resides. The manufactured device may use a clock deriving time from GPS to point to the appropriate data for the time and geographic area receiving satellite data. The output from a GPS receiver may be used to indicate the position (or location) and satellite sources used in determination. If the position (or location) is correct (within allowable error or range) and the sources correspond to those expected at the time of reading, the actuator(s) are enabled by appropriate outputs. The actuators may then be used directly to affect the desired control or may be used to reset a timer, which keeps the device in a desired state until the next position (or location) is taken later. Upon expiration of the timer without another validated position (or location) reading, positive or negative actions with respect to the controlled element, commodity, or software may be taken.

It is noted that any step of process 500 may be part of one or more software programs executed by a processor or logic circuitry for performing any of the above-described functions. Such functions may also be performed using one or more dedicated hardware devices.

Thus, in accordance with an embodiment of the present invention, allowed locations of use for an item or commodity may be loaded into the delivered item or a chipset attached to a container in which the item is delivered. Along with the allowed location, each delivered item or container may be provided with an independent clock, and sufficient memory to store data listing the satellites that will be in view for position (or location) determination as a function of time, as well as the geographic boundaries within which operation is permitted or product is kept viable. The module may periodically verify position (or location) and check to see that the signals used are from those satellites visible to the location at that time. The verification may be used to either directly control use or to reestablish a license interval or to transfer a license for portability purposes. In addition to geographical boundaries, the same system may be used to establish boundaries of altitude and time for allowable operation or use of content (e.g., weapon deployment on a military aircraft, program content dissemination on an airliner, etc.). Additional control possibilities are incorporated by use of signal superimposed either on positioning transmission or via separate channels of transmission over the same or different media.

It will thus be seen that the objects set forth above, among those made apparent from the preceding description, are efficiently attained and, because certain changes may be made in carrying out the above method(s) and in the construction(s) set forth without departing from the spirit and scope of the invention, it is intended that all matter contained in the above description and shown in the accompanying drawings shall be interpreted as illustrative and not in a limiting sense.

It is to be understood that the following claims are intended to cover all of the generic and specific features of the invention herein described and all statements of the scope of the invention, which, as a matter of language, might be said to fall therein.

What is claimed is:

1. A method of controlling access to one of at least a system and a commodity according to at least time and position, said method comprising the steps of:
storing access permission parameters, said access permission parameters including one or more positions and one or more times at which access is to be permitted;
receiving one of an access request signal and a time interval trigger signal;
determining access parameters when said one of said signals is received, said access parameters including at least a current position and a current time;
comparing said access parameters to said access permission parameters; and
permitting access to said one of at least a system and a commodity when said access parameters satisfy said access permission parameters, wherein
said current position is determined by receiving a signal from a positioning system.

2. The method of claim 1, further comprising the step of limiting access to said one of at least a system and a commodity when said access parameters do not satisfy said access permission parameters.

3. The method of claim 2, wherein said step of limiting access includes altering a state of said one of at least a system and a commodity.

4. The method of claim 2, wherein said step of limiting access includes outputting a signal indicating a permission failure.

5. The method of claim 2, wherein said step of limiting access includes prohibiting access to one or more portions of said one of at least a system and a commodity.

6. The method of claim 1, wherein said comparing step includes decoding information using said access parameters, whereby said information can be decoded properly using access parameters that satisfy said access permission parameters.

7. The method of claim 1, wherein said step of permitting access includes activating an actuator used to allow access to a shipping container.

8. The method of claim 1, wherein said positioning system is a satellite positioning system.

9. The method of claim 1, wherein said positioning system is a terrestrial positioning system that includes cellular towers.

10. The method of claim 1, wherein said positioning system includes at least one shaped beam transmitter for transmitting respective signals to respective predetermined geographic areas at respective predetermined times.

11. An apparatus for controlling access to one of at least a system and a commodity according to at least time and position, said apparatus comprising:
a memory adapted to store access permission parameters, said access permission parameters including at least one position and at least one time at which access is to be permitted;
a signal receiver adapted to receive one of an access request signal and a time interval trigger signal;
a position signal receiver adapted to receive at least a position signal indicative of a current position; and
a processor adapted to:
determine access parameters when said signal receiver receives said one of access request and time interval trigger, said access parameters including at least said current position and a current time;
compare said access parameters to said access permission parameters; and
permit access to said one of at least a system and a commodity when said access parameters satisfy said access permission parameters.

12. The apparatus of claim 11, wherein said processor is further adapted to limit access to said one of at least a system and a commodity when said access parameters do not satisfy said access permission parameters.

13. The apparatus of claim 12, wherein said processor limits access by outputting a signal for altering a state of said one of at least a system and a commodity.

14. The apparatus of claim 12, wherein said processor outputs a signal indicating a permission failure when said access parameters do not satisfy said access permission parameters.

15. The apparatus of claim 12, wherein said processor limits access by outputting a signal for prohibiting access to one or more portions of said one of at least a system and a commodity.

16. The apparatus of claim 11, wherein said processor is adapted to compare said access parameters to said access permission parameters by decoding information using said access parameters, whereby said information can be decoded properly using access parameters that satisfy said access permission parameters.

17. The apparatus of claim 11, wherein said processor permits access by activating an actuator used to allow access to a shipping container.

18. The apparatus of claim 11, wherein said position signal receiver receives said position signal from a satellite positioning system.

19. The apparatus of claim 11, wherein said position signal receiver receives said position signal from a terrestrial positioning system that includes cellular towers.

20. The apparatus of claim 11, wherein said position signal receiver receives said position signal from a positioning system that includes at least one shaped beam transmitter for transmitting respective signals to respective predetermined geographic areas at respective predetermined times.

21. An access control system, said system comprising:
one or more transportable devices, each of said one or more transportable devices including:
an access device adapted to provide access to one of at least a controlled system and a commodity; and
a signal receiver adapted to receive an access signal for said one of at least a controlled system and a commodity, whereby
said access device provides access to said one of at least a controlled system and a commodity when said signal receiver receives said access signal; and
at least one transmitter adapted to transmit a corresponding access signal for said one of at least a controlled system and a commodity of each respective transportable device to one or more predetermined positions at corresponding one or more predetermined times.

22. A set of computer program instructions for controlling access to one of at least a system and a commodity according to at least time and position, comprising:
an instruction for storing access permission parameters, said access permission parameters including at least one position and at least one time at which access is to be permitted;
an instruction for receiving one of an access request and a time interval trigger;
an instruction for determining access parameters when said one of access request and time interval trigger is received, said access parameters including at least a current position and a current time;
an instruction for comparing said access parameters to said access permission parameters; and
an instruction for permitting access to said one of at least a system and a commodity when said access parameters satisfy said access permission parameters, wherein
said current position is determined by receiving a signal from a positioning system.
